(19) United States
(12) Patent Application Publication
(10) Pub. No.: US 2006/0142162 A1
(43) Pub. Date: Jun. 29, 2006

(54) Pesticide formulations containing alkoxylated amines

(76) Inventors: Franz Xaver Scherl, Burgkirchen (DE); Joachim Hess, Hofheim (DE); Ralf Zerrer, Karlstein (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/533,474

(22) PCT Filed: Oct. 22, 2003
(86) PCT No.: PCT/EP03/11697

§ 371 Date: Nov. 21, 2005

(30) Foreign Application Priority Data
Oct. 30, 2002 (DE) 102 50 551.9

(51) Int. Cl. A01N 57/18; A01N 25/10

(52) U.S. Cl. 504/206; 504/360

(57) ABSTRACT

The invention relates in particular to compositions comprising one or more pesticides and one or more alkoxylated amines. The compositions have an improved effectiveness and are simultaneously economical, simple to handle and well tolerated by man and the environment.

The invention relates to compositions comprising pesticides, in particular preparations for improving the effect of the biological activity of plant protection agents (acaricides, bactericides, fungicides, herbicides, insecticides, molluscides, nematocides and rodenticides).

Plant protection agents are chemical or natural substances which penetrate into plant cells, plant tissue or parasitic organisms in or on plants and damage and/or destroy them.

Herbicides are the biggest component of pesticides, followed by insecticides and fungicides.

The most important herbicides are chemical substances which affect the transport system of plants, for example by inhibiting photosynthesis, fatty acid biosynthesis or amino acid biosynthesis, and result in the inhibition of germination and growth up to the point of death.

Known pesticides are, for example, herbicides of the N-(phosphonomethyl)glycine (glyphosates) class of substances. Glyphosates are used in large amounts in agriculture as very environmentally friendly and simultaneously highly active and widely applicable herbicides. They are preferably applied as water-soluble salts, for example as alkali metal, ammonium, alkylamine, alkylsulfonium, alkylphosphonium, sulfonylamine or aminoguanidine salt, or even as free acid in aqueous formulations but also in solid form with wetting agents to leaves and grasses, where they affect the transport system of the plant and destroy the plant.

The biological activity of a pesticide can be determined from the plant growth or the damage done to the plants by the action of the active agent on the leaf or via the roots as a function of the activity time and of the active concentration. A general problem is that only a fraction of the active agent develops the desired activity; by far the greatest part is lost without being used.

This ecological and economic disadvantage can be reduced by the addition to pesticide formulations of surface-active adjuvants.

An improvement in the effect of anionic pesticides can be achieved, as disclosed in WO 99/05914, by formulating the anionic active substance, together with protonated polyamines or their derivatives, as an aqueous colloidal dispersion.

U.S. Pat. No. 5,750,468 teaches that the concentration of glyphosate can be reduced without decreasing the biological activity by adding tertiary or quaternary ether amines to the formulation.

Alkoxylated primary ether amines are claimed, and their wetting, emulsifying and surfactant properties extolled, in U.S. Pat. No. 5,616,811.

Nevertheless, the development of new compositions or formulations of pesticides with improved effectiveness which are simultaneously economical, simple to handle and well tolerated by man and the environment remains an aim.

Surprisingly, the object can be achieved by the pesticide composition also comprising, in addition to the pesticide, certain alkoxylated amines.

The present invention relates to compositions comprising
a) one or more pesticides and
b) one or more compounds selected from formula I
   R¹—N{(A¹O)ᵣH}—(CH₂)₃—N{(A²O)ₛH}—[(CH₂)₃—N{(A³O)ₜH}]ₐ—(CH₂)_{y}—[N{(A⁴O)ᵤH}—(CH₂)₃]_{b}—N{(A⁵O)ᵥH}—(CH₂)₃—N{(A⁶O)_{w}H}—R² (I)
   in which
   R¹ and R² are, in each case independently of one another, a linear or branched alkyl or alkenyl residue with 6 to 30 carbon atoms, preferably 8 to 19 carbon atoms, particularly preferably a tallow fatty residue,
   A¹ to A⁶ are, in each case independently of one another, a group of the formula —C₂H₄— or —C₃H₆—,
   r, s, t, u, v and w are, in each case independently of one another, a number from 1 to 400,
   the sum of the numbers r, s, t, u, v and w has values from 10 to 600, in particular from 100 to 400,
   a and b are, in each case independently of one another, a number from 0 to 10, and
   y is a number from 2 to 10.

In the context of the present invention, the compounds of the formula I above and below also include the derivatives in which one or more nitrogen atoms have no free electron pair but in which a fourth residue Q is bonded to these nitrogen atoms, which residue is chosen from H and linear or branched alkyl groups with 1 to 6 carbon atoms, in particular H or methyl. Different residues Q can be bonded to different nitrogen atoms within a compound. In the compounds comprising one or more of these residues Q, the nitrogen atoms to which the residues Q are bonded carry a positive charge.

Corresponding counterions P can be chosen from chloride, bromide, iodide, fluoride, sulfate, hydrogensulfate, carbonate, hydrogencarbonate, phosphate, mono- and dihydrogenphosphate, pyrophosphate, metaphosphate, nitrate, methyl sulfate, phosphonate, methylphosphonate, methanedisulfonate, methanesulfonate or ethanesulfonate, or from anionic compounds of the formula R⁶SO₃^{⊖}, R⁷SO₄^{⊖} or R⁶COO^{⊖} in which R⁶ and R⁷ are linear or branched C₈-C₂₀, preferably C₁₀-C₁₈, alkyl and R⁷ is, in addition, also C₇-C₁₈ alkylphenyl. This structural element is represented subsequently, for simplicity, by the style {QP}.

The corresponding derivatives of the compounds of the formula I can therefore be described for simplicity, e.g., as follows by formula Ia
R¹—N{Q¹P¹}{(A¹O)ᵣH}—(CH₂)₃—N{Q²P²}{(A²O)ₛH}—[(CH₂)₃—N{Q³P³}{(A³O)ₜH}]ₐ—(CH₂)_{y}—[N{Q⁴P⁴}{(A⁴O)ᵤH}—(CH₂)₃]_{b}—N{Q⁵P⁵}{(A⁵O)ᵥH}—(CH₂)₃—N{Q⁶P⁶
}{(A⁶O)_{w}H}—R² (Ia)
in which
R¹, R², A¹ to A⁶, r, s, t, u, v, w, a, b and y have the meanings given above,
Q¹, Q², Q³, Q⁴, Q⁵ and Q⁶ are, in each case independently of one another, H or a linear or branched alkyl group with 1 to 6 carbon atoms, and
P¹, P², P³, P⁴, P⁵ and P⁶ are chosen, in each case independently of one another, from chloride, bromide, iodide, fluoride, sulfate, hydrogensulfate, carbonate, hydrogencarbonate, phosphate, mono- and dihydrogenphosphate, pyrophosphate, metaphosphate, nitrate, methyl sulfate, phosphonate, methylphosphonate, methanedisulfonate, methanesulfonate or ethanesulfonate, or from anionic residues of the formula R⁶SO₃^{⊖}, R⁷SO₄^{⊖} or R⁶COO^{⊖} in which R⁶ and R⁷ are linear or branched C₈-C₂₀, preferably C₁₀-C₁₈, alkyl and R⁷ is, in addition, also C₇-C₁₈ alkylphenyl.

Lauryl sulfate and cumene sulfate may be mentioned, e.g., as preferred residues P.

In the compounds of the formula I, the residues R¹ and R² are preferably a coconut fatty residue or a tallow fatty residue.

The alkoxylated amines according to formula I which are preferred are those in which
R¹ and R² are, in each case independently of one another, an alkyl residue with 8 to 19 carbon atoms, in particular a tallow fatty residue,
A¹ to A⁶ are, in each case independently of one another, a group of the formula —C₂H₄— or —C₃H₆—,
r, s, t, u, v and w are, in each case independently of one another, a number from 1 to 400,
the sum of the numbers r, s, t, u, v and w has values from 10 to 600, in particular from 100 to 400 and particularly preferably from 250 to 350,
a and b are, in each case independently of one another, a number from 0 to 10, preferably 0, and
y is 2.

In the alkoxylated amines of the formula I, the polyalkoxy groups are polyethoxy or polypropoxy polymers or ethylene oxide/propylene oxide (EO/PO) block copolymers or EO/PO random copolymers. 1 to 400 EO or PO or EO/PO units in a random distribution can occur within a chain. Altogether, the compound of the formula I can comprise 10 to 600, preferably 100 to 400, particularly preferably 250 to 350, EO or PO or EO/PO units.

Surprisingly, both solid and liquid pesticide formulations with excellent solubility behavior in water can be prepared with alkoxylated amines according to formula I. An additional performance advantage is the high phase stability of highly concentrated aqueous formulations prepared from anionic pesticides, in particular glyphosates in the salt form, optionally agrochemical salts and alkoxylated amine according to formula I. The ionic components do not crystallize out when alkoxylated amine is added, even with a relatively long storage time.

In addition to the high electrolyte stability, the adjuvant used according to the invention shows an improvement in the compatibility and an improvement in the biological activity of the active agent in the plants.

The alkoxylated amines according to the formula I used in pesticide formulations as adjuvants according to the invention are prepared in a multistage synthesis, for example as follows.

A primary alkylamine, for example coconut amine or tallow amine, is placed under N₂, with or without a catalyst, and acrylonitrile is metered in, at a temperature of 40° C. to 90° C., in 1 to 2 hours, the molar ratio of amine to nitrile being from 1:0.95 to 1:1.20. The reaction is exothermic. After the end of the addition, the mixture is stirred at the reaction temperature for 2 to 6 hours. The nitrile formed is washed, first with dilute sodium hydroxide solution and then with water. The nitrile is hydrogenated under standard conditions (shaking autoclave) with a suitable catalyst (e.g. Raney nickel, at 70° C. to 120° C. in the presence of ammonia and a hydrogen pressure of 150 to 180 bar to constant pressure. After filtering the contents of the autoclave, the amine obtained is distilled under water jet vacuum.

The amine obtained can be reacted further, e.g. it can once again in a similar way be reacted with acrylonitrile and hydrogenated to the triamine. The triamine obtained can be converted, by further reaction with acrylonitrile and subsequent hydrogenation, to the tetramine, etc.

To prepare alkoxylated amines according to the formula I, the amine obtained by reaction with acrylonitrile and subsequent hydrogenation is placed under an N₂ atmosphere with 2-propanol, and dialdehyde, for example glyoxal solution, is added dropwise with stirring in an amine to dialdehyde molar ratio of 1:0.45 to 1:0.55, the reaction temperature not being allowed to exceed 30° C. to 50° C. The afterreaction occurs at 50° C. to 70° C. in 2 to 4 hours. The Schiff base formed is hydrogenated under standard hydrogenation conditions (stirred autoclave, hydrogenation catalyst, e.g., Raney nickel) at 70 to 100 bar hydrogen pressure and 70° C. to 90° C. to constant pressure. The polyamine formed is filtered and, to remove the 2-propanol/water mixture, is stripped, first at normal pressure and then under water jet vacuum.

To carry out the alkoxylation, dry polyamine is placed under an N₂ atmosphere and is alkoxylated in 2 steps, without and with a suitable basic catalyst, e.g. NaOH, at 140 to 200° C. In the course of this, ethylene oxide and/or propylene oxide is gradually added up to the desired degree of alkoxylation (amine number). The afterreaction amounts to 1 to 3 hours, depending on the alkylene oxide.

The corresponding derivatives of the compounds of formula I, the compounds of the formula Ia, in which one or more residues Q are bonded to one or more nitrogen atoms, can, e.g., be prepared from the compounds of the formula I according to methods well known to a person skilled in the art, for example by appropriate reaction of the compounds of the formula I with HCl or methyl chloride.

According to the invention, the alkoxylated amines of the formula I are suitable as adjuvants in pesticide formulations for improving the biological activity of herbicides, insecticides, fungicides, acaricides, bactericides, molluscides, nematocides and rodenticides. In a preferred embodiment, these compounds are added to herbicide formulations. Suitable herbicides are, without the invention being restricted to these, acifluorfen, asulam, benazolin, bentazone, bilanafos, bromacil, bromoxynil, chloramben, clopyralid, 2,4-D, 2,4-DB, dalapon, dicamba, dichlorprop, diclofop, endothal, fenac, fenoxaprop, flamprop, fluazifop, flumiclorac, fluoroglycofen, fomesafen, fosamine, glufosinate, haloxyfop, imazapic, imazamethabenz, imazamox, imazapyr, imazaquin, imazethapyr, ioxynil, MCPA, MCPB, mecoprop, methylarsonic acid, naptalam, picloram, quinclorac, quizalofop, 2,3,6-TBA and TCA.

Preferred pesticides are herbicides of the N-(phosphonomethyl)glycine (glyphosates) class of substances. Among the glyphosates, the free acid and in particular the water-soluble salts are preferred. In turn, among water-soluble salts, the alkali metal, ammonium, alkylamine, alkylsulfonium, alkylphosphonium, sulfonylamine and aminoguanidine salts are preferred. In this connection, “alkylamine” is particularly preferably “isopropylamine”.

The content of compounds of the formula I in the pesticide formulations according to the invention can vary within wide limits. The following formulations are preferred.

Concentrate formulations which are diluted before use (ready-to-use or built-in compositions) comprise the pesticide preferably in the amounts of 5 to 60 weight %, particularly preferably 20 to 40 weight %, and compounds of the formula I preferably in the amounts of 5 to 50 weight %. These amounts refer to the combined concentrate formulation.

Alternatively, the formulations according to the invention can be prepared in the solid form, as powder, pellets, tablets or granules, which are dissolved in water before use. Solid preparations comprise the pesticide preferably in the amounts of 20 to 80 weight %, particularly preferably of 50 to 75 weight %, especially preferably of 60 to 70 weight %, and compounds of the formula I preferably in the amounts of 5 to 80 weight %, particularly preferably of 30 to 60 weight %. These amounts refer to the combined solid preparation.

The invention furthermore relates to the use of
a) one or more pesticides and
b) one or more compounds selected from formula I
   R¹—N{(A¹O)ᵣH}—(CH₂)₃—N{(A²O)ₛH}—[(CH₂)₃—N{(A³O)ₜH}]ₐ—(CH₂)_{y}—[N{(A⁴O)ᵤH}—(CH₂)₃]_{b}—N{(A⁵O)ᵥH}—(CH₂)₃—N{(A⁶O)_{w}H}—R² (I)
   in which
   R¹ and R² are, in each case independently of one another, a linear or branched alkyl or alkenyl residue with 6 to 30 carbon atoms,
   A¹ to A⁶ are, in each case independently of one another, a group of the formula —C₂H₄— or —C₃H₆—,
   r, s, t, u, v and w are, in each case independently of one another, a number from 1 to 400,
   the sum of the numbers r, s, t, u, v and w has values from 10 to 600,
   a and b are, in each case independently of one another, a number from 0 to 10, and
   y is a number from 2 to 10,
      the compounds of the formula I also including those derivatives in which a fourth residue is bonded to one or more nitrogen atoms, which residue is chosen from H and linear or branched alkyl groups with 1 to 6 carbon atoms, and the counterions of these derivatives are chosen from chloride, bromide, iodide, fluoride, sulfate, hydrogensulfate, carbonate, hydrogencarbonate, phosphate, mono- and dihydrogenphosphate, pyrophosphate, metaphosphate, nitrate, methyl sulfate, phosphonate, methylphosphonate, methanedisulfonate, methanesulfonate, or ethanesulfonate, or from anionic compounds of the formula R⁶SO₃⁻ and R⁷SO₄⁻ or R⁶COO⁻ in which R⁶ and R⁷ are linear or branched C₈-C₂₀, preferably C₁₀-C₁₈, alkyl and R⁷ is, in addition, also C₇-C₁₈ alkylphenyl,
      in controlling and/or combating weeds.

In this connection, the pesticide or pesticides and the one or more compounds of the formula I can also exist in the form of a tank-mix composition. In such a composition, both the pesticide or pesticides and the one or more compounds of the formula I are separate from one another. Both compositions are mixed with one another before application, generally shortly before. In tank-mix processes, the pesticide, before the mixing, is preferably present in water or in an organic solvent, e.g. in aromatic or aliphatic hydrocarbons, such as toluene, xylene or Solvesso, halogenated hydrocarbons, such as tetrachloromethane, chloroform, methylene chloride or dichloroethane, or methylated oils, such as methyl esters of soybean oil or rapeseed oil. In tank-mix processes, the compound of the formula I, before the mixing, is preferably present without solvent or in water. In a preferred embodiment, both the pesticide or pesticides and the one or more compounds of the formula I are present in water.

In the spray mixture, the concentration of the pesticide or pesticides is preferably from 0.001 to 10 weight %, particularly preferably from 0.025 to 3 weight % and especially preferably from 0.025 to 2 weight %, based on the combined spray mixture. The concentration of the one or more compounds of the formula I in the spray mixture is preferably from 0.01 to 10 weight %, particularly preferably from 0.1 to 2 weight % and especially preferably from 0.2 to 1 weight %, based on the combined spray mixture. The ratio of adjuvant to pesticide in the spray mixture is preferably from 1:10 to 500:1, particularly preferably from 1:4 to 4:1.

The formulations according to the invention can comprise thickeners, antigelling agents, antifreezes, solvents, dispersants, emulsifiers, preservatives, additional adjuvants, binders, antifoaming agents, thinners, disintegrating agents and wetting agents. Use may be made, as thickeners, of xanthan gum and/or cellulose, for example carboxy-, methyl-, ethyl- or propylcellulose, in the amounts of 0.01 to 5 weight %, based on the finished composition. Suitable solvents are monopropylene glycol and animal and mineral oils. Suitable dispersants and emulsifiers are nonionic, amphoteric, cationic and anionic surfactants. Use may be made, as preservatives, of organic acids and their esters, for example ascorbic acid, ascorbyl palmitate, sorbate, benzoic acid, methyl and propyl 4-hydroxybenzoate, propionates, phenol, for example 2-phenylphenoxide, 1,2-benzisothiazolin-3-one, formaldehyde, sulfurous acid and salts thereof. Suitable antifoaming agents are polysilicones. Additional adjuvants can be polyglycerol esters, alcohol ethoxylates, alkylpolysaccharides, fatty amine ethoxylates, sorbitan and sorbitol ethoxylate derivatives and derivatives of alk(en)ylsuccinic anhydride. The mixing ratio of these adjuvants to the alkoxylated amines according to formula I used according to the invention can be in the range from 1:10 to 10:1. Suitable binders for solid formulations are polyvinylpyrrolidone, polyvinyl alcohol, carboxymethylcellulose, sugar, for example sucrose, sorbitol or starch. Suitable thinners, absorbents or carriers are carbon black, tallow, kaolin, aluminum, calcium or magnesium stearate, sodium tripolyphosphate, sodium tetraborate, sodium sulfate, silicates and sodium benzoate. Effective disintegrating agents are cellulose, for example carboxymethylcellulose, polyvinylpyrrolidone, sodium or potassium acetate, carbonates, bicarbonates, sesquicarbonates, ammonium sulfate or potassium hydrogenphosphate. Use may be made, as wetting agents, of alcohol ethoxylates/propoxylates.

A great performance advantage is the high stability toward salts of the pesticide formulations according to the invention with alkoxylated amines according to formula I in an aqueous medium, even at high pesticide concentration.

In a particularly preferred embodiment, the pesticide formulations according to the invention comprise, in addition to the active agent and one or more alkoxylated amines according to formula I, agrochemical salts, preferably ammonium salts, particularly preferably ammonium sulfate, ammonium nitrate, ammonium phosphate, ammonium thiocyanate and/or ammonium chloride.

The formulations according to the invention can be applied by the usual methods. Aqueous concentrates and solid formulations are diluted with the corresponding amount of water before application.

Pesticide amounts ranging from 0.1 to 5 kg, preferably 0.3 to 2.5 kg, are applied per hectare. The proportion of the adjuvant according to the invention ranges from 0.002 to approximately 1.0 kg/ha. The volume of the pesticide formulation prepared for spray application preferably ranges from 50 to 1000 l/ha but can, for special application methods, for example for control droplet application, also be 10 to 50 l/ha.

1. A composition comprising
a) at least one pesticide and
b) at least one compound selected from formula I
R¹—N{(A¹O)ᵣH}—(CH₂)₃—N{(A²O)ₛH}—[(CH₂)₃—N{(A³O)ₜH}]ₐ—(CH₂)_{y}—[N{(A⁴O)ᵤH}—(CH₂)₃]_{b}—N{(A⁵O)ᵥH}—(CH₂)₃—N{(A⁶O)_{w}H}—R² (I)
in which
R¹ and R² are, in each case independently of one another, a linear or branched alkyl or alkenyl residue with 6 to 30 carbon atoms,
A¹ to A⁶ are, in each case independently of one another, a group of the formula —C₂H₄— or —C₃H₆—,
r, s, t, u, v and w are, in each case independently of one another, a number from 1 to 400,
the sum of the numbers r, s, t, u, v and w has values from 10 to 600,
a and b are, in each case independently of one another, a number from 0 to 10, and
y is a number from 2 to 10,
the compounds of the formula I also including those derivatives in which a fourth residue is bonded to one or more nitrogen atoms, said fourth residue chosen from H and linear or branched alkyl groups with 1 to 6 carbon atoms, wherein the counterions of these derivatives are selected from the group consisting of chloride, bromide, iodide, fluoride, sulfate, hydrogensulfate, carbonate, hydrogencarbonate, phosphate, mono- and dihydrogenphosphate, pyrophosphate, metaphosphate, nitrate, methyl sulfate, phosphonate, methylphosphonate, methanedisulfonate, methanesulfonate, ethanesulfonate, and mixtures thereof, or from an anionic compound of the formula R⁶SO₃⁻ or R⁷SO₄⁻ or R⁶COO⁻ and mixtures thereof, in which R⁶ is a linear or branched C₈-C₂₀ alkyl, and R⁷ is a linear or branched C₈-C₂₀ alkyl or a C₇-C₁₈ alkylphenyl.

2. The composition as claimed in claim 1, wherein the
pesticide is a glyphosate.

3. The composition as claimed in claim 2, wherein
glyphosate is present as free acid or is a salt selected from the group consisting of an alkali metal, ammonium, alkylamine, alkylsulfonium, alkylphosphonium, sulfonylamine, aminoguanidine salt, and mixtures thereof.

4. The composition of claim 1, which comprises compounds of the formula I in which
R¹ and R² are, in each case independently of one another, an alkyl residue with 8 to 19 carbon atoms, and
a and b are, in each case independently of one another, a number from 0 to 10, and
y is 2.

5. The composition as claimed in claim 4, wherein a and b are 0.

6. The composition of claim 1, wherein R¹ and R² are a tallow fatty residue.

7. The composition of claim 1, which is in the form of a concentrate formulation to be diluted before use and comprises 5 to 60 weight % of the pesticide and 5 to 50 weight % of the compound of formula I.

8. The composition of claim 1, which in the form of a solid formulation to be dissolved in water before use and comprises 20 to 80 weight % of pesticide and 5 to 80 weight % of the compound of formula I.

9. The composition of claim 1, which is in the form of a spray mixture and comprises 0.001 to 10 weight % of pesticide and 0.01 to 10 weight % of at least one compound of formula I.

10. The composition of claim 1,
which further comprises an agrochemical salt.

11. The composition as claimed in claim 10, wherein the agrochemical salt is selected from the group consisting of ammonium sulfate, ammonium nitrate, ammonium phosphate, ammonium thiocyanate, ammonium chloride, and mixtures thereof.

12. A method for controlling weeds, said method comprising contacting the weeds with a composition comprising:
a) at least one pesticide and
b) at least one compound selected from formula I
R¹—N{(A¹O)ᵣH}—(CH₂)₃—N{(A²O)ₛH}—[(CH₂)₃—N{(A³O)ₜH}]ₐ—(CH₂)_{y}—[N{(A⁴O)ᵤH}—(CH₂)₃]_{b}—N{(A⁵O)ᵥH}—(CH₂)₃—N{(A⁶O)_{w}H}—R² (I)
in which
R¹ and R² are, in each case independently of one another, a linear or branched alkyl or alkenyl residue with 6 to 30 carbon atoms,
A¹ to A⁶ are, in each case independently of one another, a group of the formula —C₂H₄— or —C₃H₆—,
r, s, t, u, v and w are, in each case independently of one another, a number from 1 to 400,
the sum of the numbers r, s, t, u, v and w has values from 10 to 600,
a and b are, in each case independently of one another, a number from 0 to 10, and
y is a number from 2 to 10,
the compound of formula I also including derivatives in which a fourth residue is bonded to one or more nitrogen atoms, said fourth residue is chosen from H and linear or branched alkyl groups with 1 to 6 carbon atoms, and wherein counterions of these derivatives are selected from the group consisting of chloride, bromide, iodide, fluoride, sulfate, hydrogensulfate, carbonate, hydrogencarbonate, phosphate, mono- and dihydrogenphosphate, pyrophosphate, metaphosphate, nitrate, methyl sulfate, phosphonate, methylphosphonate, methanedisulfonate, methanesulfonate, ethanesulfonate, and mixtures thereof, or from anionic compounds of the formula R⁶SO₃⁻ and R⁷SO₄⁻ or R⁶COO⁻ in which R⁶ and is a linear or branched C₈-C₂₀ alkyl, and R⁷ is a linear or branched C₈-C₂₀ alkyl, or a C₇-C₁₈ alkylphenyl,

13. The method of claim 12, taking place in a tank-mix process.

14. The method of claim 12, wherein the at least one pesticide is present in water or an organic solvent and the at least one compound of formula I is present without solvent or in water and with or without water or solvent, the pesticide and the compound of formula 1 are mixed with one another before application.

15. The method of claim 14, wherein the pesticide and the compound of formula I are present in water.

16. The composition of claim 10, further comprising an ammonium salt.
